(19) United States
(12) Patent Application Publication
(10) Pub. No.: US 2017/0171615 A1
(43) Pub. Date: Jun. 15, 2017

(54) Method and Electronic Device for Controlling Video Playing

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Gengping XIANG, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/241,885

(22) Filed: Aug. 19, 2016

Related U.S. Application Data
(63) Continuation of application No. PCT/CN2016/089261, filed on Jul. 7, 2016.

(30) Foreign Application Priority Data
Dec. 15, 2015 (CN) 201510933496.2

(51) Int. Cl. H04N 21/442; G06T 1/00; H04N 1/32; H04N 21/45; G11B 27/036; H04L 29/12; H04N 21/8358

(52) U.S. Cl. CPC H04N 21/44236; H04L 45/741; H04L 61/6022; H04L 61/6054; G06T 1/0021; H04N 21/8358; H04N 21/4516; G11B 27/036; H04N 1/32293

(57) ABSTRACT

The present disclosure relates to a method and electronic device for controlling video play. Wherein, the method for controlling video play may include: acquiring identity information of a current playing device when a video is played; generating a watermark logo comprising the identity information; and displaying the watermark logo on a playing interface of the video.

### CROSS REFERENCE TO RELATED APPLICATION

The present disclosure is a continuation of a PCT application No. PCT/CN2016/089261 filed on Jul. 7, 2016, and claims priority to Chinese Patent Application No. 201510933496.2 titled as “METHOD AND DEVICE FOR CONTROLLING VIDEO PLAY,” filed with State Intellectual Property Office Of China on Dec. 15, 2015, which is incorporated herein by reference in its entirety.

### TECHNICAL FIELD

The present disclosure relates to the field of data technologies, and in particular, to a method and electronic device for controlling video play.

### BACKGROUND

Due to ever-growing importance of copyright protection, some firms may adopt some anti-pirateship measures, such as adding a significant logo on the upper right corner of the video play interface or adding a fixed anti-pirateship mark at a fixed position of the video stream.

However, this kind of measure has only limited effects, which may only indicate the copyright owner to reduce pirateship. Once a video is pirated by other website or user, the platform which plays the video, rather than the pirate who pirates the video, can be found, and thus it cannot provide enough protection and help for the copyright owners.

### SUMMARY

To overcome the above problems in related art, the present disclosure may provide a method and electronic device for controlling video play.

According to a first aspect of embodiments of the present disclosure, a method for controlling video play may be provided, comprising:

acquiring identity information of a current playing device when a video is played;

generating a watermark logo comprising the identity information; and

displaying the watermark logo on a playing interface of the video.

According to a second aspect of embodiments of the present disclosure, a non-volatile computer readable storage medium may be provided which is stored with computer executable instructions configured to perform the above described method for controlling video play.

According to a third aspect of embodiments of the present disclosure, an electronic device may be further provided, including: at least one processor; and a memory communicatively connected with the at least one processor, wherein the memory may be stored with instructions which can be executed by the at least one processor, and which, when executed by the at least one processor, to enable the at least one processor to implement the method for controlling video play according to the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for controlling video play according to one exemplary embodiment of the present disclosure;

FIG. 2 is a flowchart of another method for controlling video play according to one exemplary embodiment of the present disclosure;

FIG. 3 is a flowchart of yet another method for controlling video play according to one exemplary embodiment of the present disclosure;

FIG. 4 is a flowchart of still yet another method for controlling video play according to one exemplary embodiment of the present disclosure;

FIG. 5 is a scene schematic according to one exemplary embodiment of the present disclosure;

FIG. 6 is a flowchart of another method for controlling video play according to one exemplary embodiment of the present disclosure;

FIG. 7 is a flowchart of yet another method for controlling video play according to one exemplary embodiment of the present disclosure;

FIG. 8 is a flowchart of yet another method for controlling video play according to one exemplary embodiment of the present disclosure;

FIG. 9 is a structure diagram of an device for controlling video play according to one exemplary embodiment of the present disclosure;

FIG. 10 is a structure diagram of another device for controlling video play according to one exemplary embodiment of the present disclosure;

FIG. 11 is a structure diagram of yet another device for controlling video play according to one exemplary embodiment of the present disclosure;

FIG. 12 is a structure diagram of yet another device for controlling video play according to one exemplary embodiment of the present disclosure;

FIG. 13 is a structure diagram of yet another device for controlling video play according to one exemplary embodiment of the present disclosure;

FIG. 14 is a structure diagram of yet another device for controlling video play according to one exemplary embodiment of the present disclosure;

FIG. 15 is a structure diagram of yet another device for controlling video play according to one exemplary embodiment of the present disclosure; and

FIG. 16 is a hardware structure schematic illustrating an electronic device for controlling video play according to embodiments of the present disclosure.

### DETAILED DESCRIPTION

Here, exemplary embodiments are illustrated in details by way of example, wherein the examples are shown in the accompanying drawings. Where the description below relates to figures, unless otherwise indicates, the same reference numeral in different figures represents same or like elements. Exemplary embodiments below do not represent all embodiments in accordance with the present disclosure. On the contrary, they are merely examples of the device and method in accordance with some aspects of the present disclosure as defined in the accompanying claims.

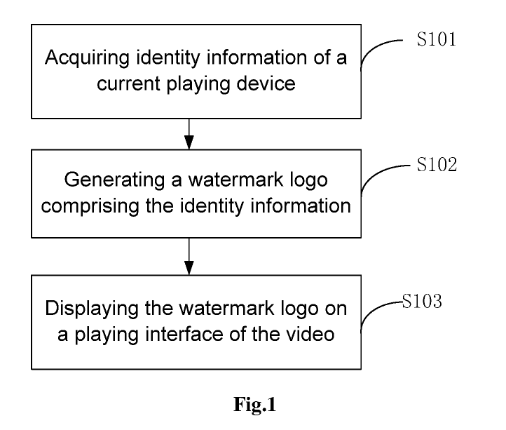

FIG. 1 is a flowchart of a method for controlling video play according to one exemplary embodiment of the present disclosure. The method may be applied to terminal devices, such as personal computer, cell phone, or tablet computer, etc. Referring to FIG. 1, the method may include the following steps.

In step S101, when a video is played, identity information of a current playing device may be acquired.

When a video is played on a device, the video may be played through video play software of the device, such as commonly seen IQIYI Video, SOHU Video and etc., wherein the video play software may be installed in the terminal device. Here, the device to play the video is called a current playing device (similarly hereinafter). Each playing device has unique and inalterable identity information. In the embodiment, the identity information may be used to identify the playing device, thus identity information of the current playing device may be identified through the identity information.

In embodiments of the present disclosure, identity information of different playing devices and user information corresponding to playing devices or other associated information may be prestored so that identity information of a playing device may be acquired, and associated user information may be found from the playing device.

When identity information of a current playing device is acquired, in step S102, a watermark logo comprising the identity information may be generated.

The watermark logo may be a logo displayed on video images when a video is played. The watermark logo may be generated mainly according to the identity information. Because the identity information is a unique and fixed logo, the generated watermark logo may be the unique and fixed identifying logo. By the watermark logo, the source from which the video is played may be identified. In embodiments of the present disclosure, the watermark logo may be an integral watermark logo or a plurality of sub-logo components. Related description may be referred to related embodiments below.

When the watermark logo is generated, in step S103, the watermark logo may be displayed on a playing interface of the video.

When a video is played, video images present in people's view may include a video stream image and a playing interface. The video stream image may be a video stream. The playing interface may be an interface overlapped above the video stream. The playing interface and the video stream may be two entities separate from each other. Therefore, in embodiments of the present disclosure, when the watermark logo is generated, it may be controlled to be displayed on the playing interface of the video.

Moreover, the watermark logo may also be stored in video stream and thus may be displayed when the video is played, so that the watermark logo may be observed with naked eyes or identified by an associated device.

With the method, when a video is played, a watermark logo of the identity information of the device for playing the video may be generated and displayed on the playing interface of the video, thus the risk of pirateship can be reduced or avoided effectively. With a watermark logo, the video may be stolen by pirates together with the watermark logo, which makes it easier to see whether the video is a pirated video with the watermark logo; meanwhile, since the watermark logo indicates identity information of playing devices, user information, even the pirate, related to the playing device, may be traced and found with the watermark logo. In this way, the copyright of the video can be protected effectively; further, the protection of intellectual property may be improved.

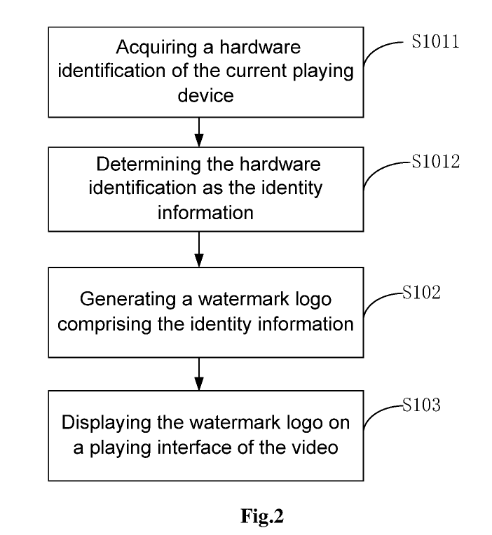

FIG. 2 is a flowchart of a method for controlling video play according to one exemplary embodiment of the present disclosure. FIG. 2 is based on the above step S101. The method may include the following steps.

In step S1011, a hardware identification of the current playing device may be acquired.

The current playing device may be a device installed with video play software. Each playing device has an unique hardware identification, which may be a MAC (Media Access Control) address, an IMEI (International Mobile Equipment Identity) identification code, a CPU (Central Processing Unit) number and an IP (Internet Protocol) address.

In embodiments of the present disclosure, the hardware identification available to acquire may be one or more combination of the above MAC address, IMEI identification code, CPU number and IP address, such as the combination of MAC address and IP address. Moreover, the hardware identification is not limited to the above identifications but may also be like the title of a WI-FI (Wireless-Fidelity) hotspot through which playing devices are connected to wireless networks.

When the hardware identification of the current playing device is acquired, in step S1012, the hardware identification may be determined as the identity information.

In step S102, a watermark logo comprising the identity information may be generated.

In step S103, the watermark logo may be displayed on a playing interface of the video.

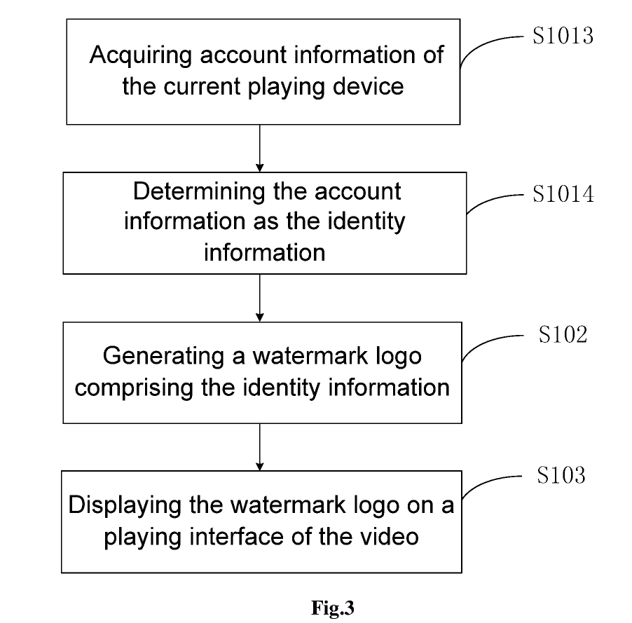

FIG. 3 is a flowchart of another method for controlling video play according to one exemplary embodiment of the present disclosure. The method is based on the above step S101. The method may include the following steps.

When a video is played, in step S1013, account information of the current playing device may be acquired.

The account information may be account information of a video player in the current playing device, or, account information of a program associated with the video player. For example, if the video player in the playing device is Youku player, the account information is the login account in logging in the Youku player, or other associated programs provided in the playing device, such as the login account of Tudou player associated with the Youku player, or etc. Certainly, in embodiments of the present disclosure, the account information is also unique and fixed.

When account information of the current playing device is acquired, in step S1014, the account information may be determined as the identity information.

In step S102, a watermark logo comprising the identity information may be generated.

In step S103, the watermark logo may be displayed on a playing interface of the video.

Through the method mentioned in above FIG. 2 and FIG. 3 with respect to the above step S101, the unique identity information of the playing device may be acquired. The identity information may be used as identity information of the playing device. With the unique identity information, the playing device's identity may be determined quickly. Then with the stored user information of the playing device, corresponding user may be traced and found. Thus, the problem in the prior art where the pirate cannot be found may be avoided.

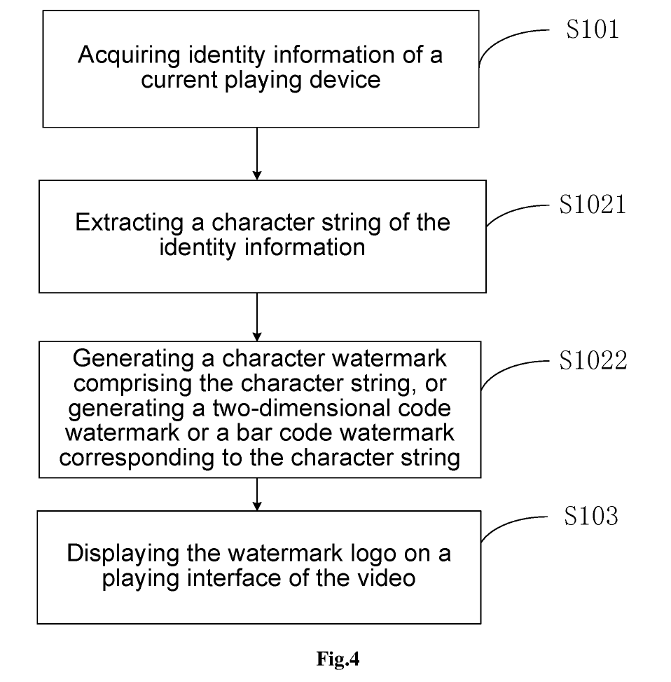

FIG. 4 is a flowchart of a method for controlling video play according to one exemplary embodiment of the present disclosure. Referring to FIG. 4, the method may include the following steps.

In step S101, identity information of a current playing device may be acquired.

In step S1021, a character string of the identity information may be extracted.

The identity information may be a hardware identification of the playing device, such as a MAC address or an IMEI identification code and etc.; the identity information may also be account information of the playing device, such as the account information for logging in a video player on the playing device and etc. The hardware identification may be converted into a form of a character string. For example, the MAC address may be in a form of 1E: 2D: 2F; FD, so as to convert the MAC address into a corresponding character string; for example, the IMEI identification code itself may be a string of characters, thus, a character string of the IMEI identification code may be acquired directly.

When a character string of the identity information is extracted, in step S1022, a character watermark comprising the character string may be generated, or, a two-dimensional code watermark or a bar code watermark corresponding to the character string may be generated.

In embodiments of the present disclosure, a corresponding character watermark may be generated according to the character string. For example, the character string is 01234567, then its corresponding generated watermark is 01234567. Because a watermark in the form of characters may be easier to be cracked or removed manually, a two-dimensional code watermark or a bar code watermark which is difficult to be cracked may also be generated according to the character string, moreover, the two-dimensional code watermark or the bar code watermark is corresponding to the character string.

In step S103, the watermark logo may be displayed on a playing interface of the video.

With the method, identity information of the character string may be extracted to generate a corresponding character watermark, a two-dimensional code watermark or a bar code watermark. In this way, the character watermark, the two-dimensional code watermark or the bar code watermark may be displayed on the video interface to add a corresponding anti-pirateship logo, which may prevent the video from being pirated.

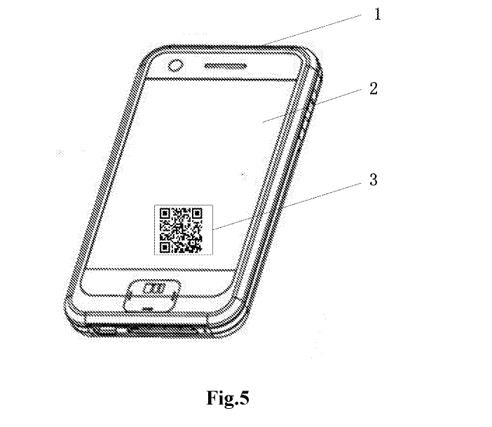

Referring to FIG. 5, it is a scene diagram according to one exemplary embodiment, including a cell phone 1, a screen 2 provided on the cell phone 1 and a logo frame 3 provided in the screen 2, wherein a two-dimensional code watermark is provided in the logo frame 3 (the embodiment of the present disclosure takes a two-dimensional code watermark as an example and video images played in the video may be omitted).

In the embodiment of the present disclosure, the two-dimensional code watermark may be two-dimensional code information generated by a MAC address or an IMEI identification code of the cell phone 1; the position of the logo frame 3 is not limited to the position in the figure and may be located in any interface of the video play interface. Besides, during the specific process, the logo frame may be a logo frame in random position, or a logo frame in fixed position.

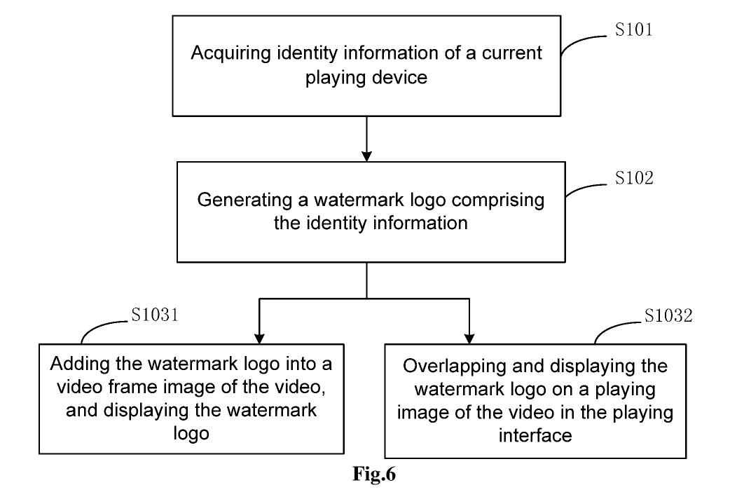

FIG. 6 is a flowchart of a method for controlling video play according to one exemplary embodiment. Referring to FIG. 6, the method may include the following steps.

When a watermark logo comprising the identity information is generated, in step S1031, the watermark logo may be added into a video frame image of the video, and displayed.

In the embodiment of the present disclosure, the watermark logo may be added into a video frame image of the video. That is, when a video is watched in a video player, at the same time of downloading the video stream, the watermark logo may be generated in a position of the video stream and combined together with the video stream.

When a watermark logo comprising the identity information is generated, in step S1032, the watermark logo may be overlapped and displayed on a playing image of the video in the playing interface.

In the embodiment of the disclosure, the playing image and playing interface of the video may be two separate displaying images. The watermark logo may be displayed in the playing interface, thus the watermark logo may be overlapped on the playing image.

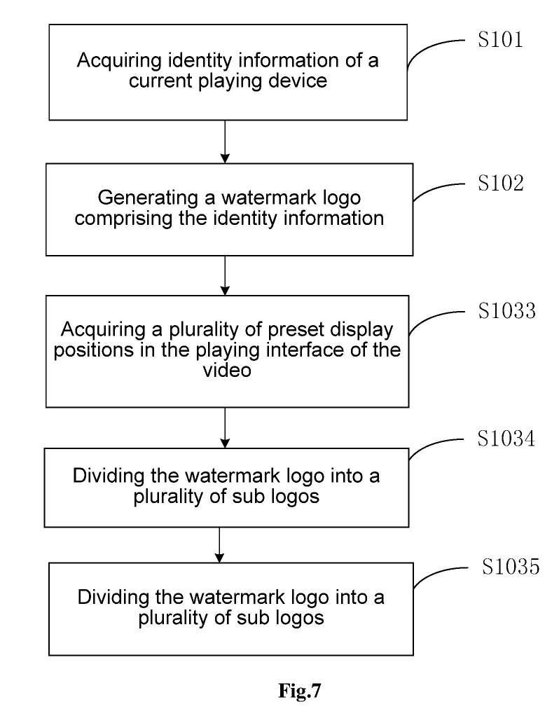

Based on the above FIG. 6, FIG. 7 is a flowchart of a method for controlling video play according to one exemplary embodiment of the present disclosure. Referring to FIG. 7, the method may include the following steps.

In step S101, identity information of a current playing device may be acquired.

In step S102, a watermark logo comprising the identity information may be generated.

In step S1033, a plurality of preset display positions in the playing interface of the video may be acquired.

In the embodiment of the disclosure, a plurality of display positions may be provided beforehand on the playing interface of the video. The display positions may be random or fixed positions of the playing interface. By acquiring the plurality of preset display positions. the watermark logo may be positioned within the preset display positions

When a plurality of preset display positions in the playing interface of the video are acquired, in step S1034, the watermark logo may be divided into a plurality of sub logos.

The sub logos are logos formed by dividing the watermark logo. For example, the watermark logo is divided into four parts, thus 4 sub logos are included. Besides, the number of the divided sub logos is same to the number of the preset display positions, in such a way that each preset display position may be able to accommodate a sub logo.

When the watermark logo is divided into a plurality of sub logos, in step S1035, one of the sub logos corresponding may be displayed on a corresponding one of the plurality of preset display positions, respectively.

In the embodiment of the disclosure, the number of the preset display positions is same to the number of sub logos, in such a way that each sub logo can be put in a corresponding preset display position to display. Wherein, the preset display positions may build one-to-one corresponding relations with the sub logos, respectively, so that each sub logo is put in a preset display position; the preset display positions may also not build one-to-one corresponding relations with the sub logos, respectively, so that each sub logo may be displayed randomly in a preset display position.

Using the method of dividing the watermark logo into a plurality of sub logos and displaying the sub logos in each of the preset display positions, sub logos may be displayed on a plurality of preset display positions in the playing interface of the video. Thus, the watermark logo, or the sub logos, may be better protected; further, the safety of the video may be improved effectively.

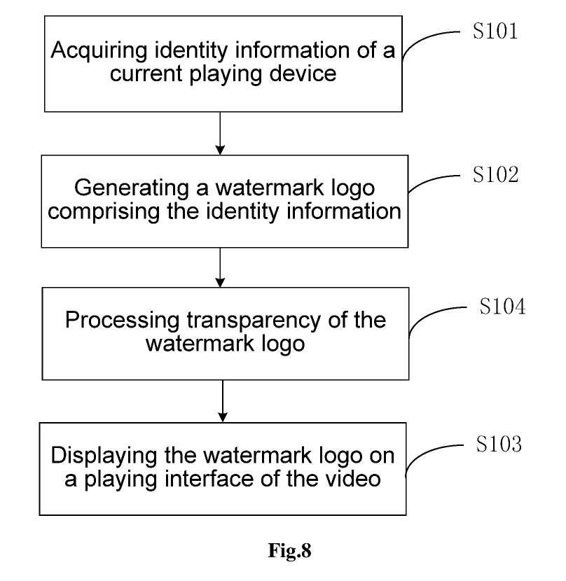

Additionally, based on FIG. 1, embodiments of the present disclosure may further provide another flowchart of a method for controlling video play. Referring to FIG. 8, the method may include the following steps.

When a video is played, in step S101, identity information of a current playing device may be acquired.

When identity information of a current playing device is acquired, in step S102, a watermark logo comprising the identity information may be generated.

When a watermark logo comprising the identity information is generated, in step S104, the watermark logo may be transparentized.

In the embodiment of the disclosure, transparency of the watermark logo may be increased by the process of transparentizing. In the specific process, transparency represented by the watermark logo may be processed as above 90% until it is invisible to the naked eye, so that pirates who stole the video fail to acquire the watermark logo with greater transparency. In this way, after the video is stolen, by some special equipment, for example, a scanner capable of identifying a high level of transparency, identification of the playing device represented by the watermark may be acquired.

When transparency of the watermark logo is processed, in step S103, the watermark logo may be displayed on a playing interface of the video.

Relevant description of the above steps S101, S102 and S103 may be referred to the description about FIG. 1 and detailed description is omitted here for avoidance of redundancy.

Using the method of processing transparency of the watermark logo, even though the video is stolen, identity information of the playing device represented by the watermark logo may be acquired after scanning the watermark logo having transparency; further with prestored account information associated with the playing device of the identity information, the pirate may be found, thus intellectual property results may be effectively protected.

The above FIG. 1 to FIG. 8 are embodiments according to related method for controlling video play. Wherein, each embodiment in this specification is described with its own special features, and reference may be made to each other for the same or similar parts among the embodiments.

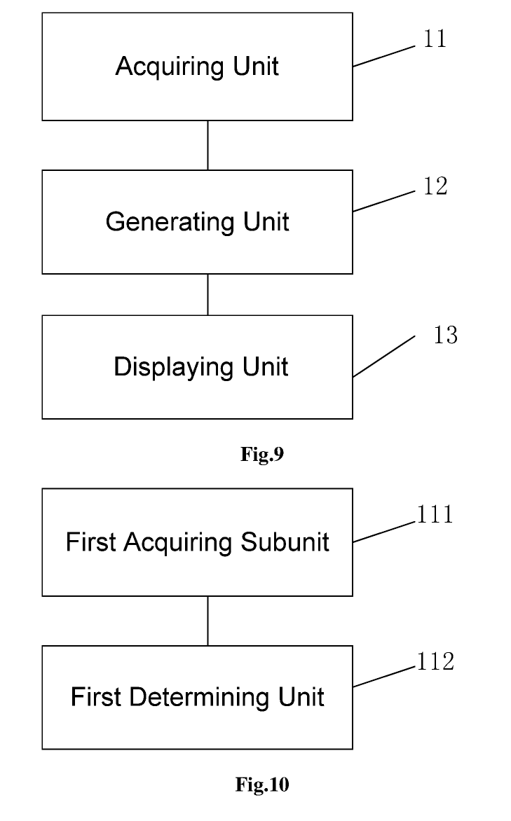

FIG. 9 is a structure diagram of a device for controlling video play according to one exemplary embodiment of the present disclosure. The device may be installed in a playing device, such as a personal computer, a cell phone, or a tablet computer, etc. Certainly, the playing device may also be provided with related video play software or video play program. The device may be provided in video play software or video play program. Referring to FIG. 9, the device may include an acquiring unit 11, a generating unit 12 and a displaying unit 13.

Wherein, the acquiring unit 11 may be configured to acquire identity information of a current playing device when a video is played; wherein the identity information is information to identify identity of the current playing device.

the generating unit 12 may be configured to generate a watermark logo comprising the identity information; and

the displaying unit 13 may be configured to display the watermark logo on a playing interface of the video.

Using the device, a watermark logo may be generated and displayed on a video play interface to give pirates a warning so as to prevent the pirates from stealing the video as soon as possible; besides, the playing device from which the video is pirated and its user information may be acquired by identity information of the watermark logo, which may effectively improves safety of the video and protect intellectual property.

Based on FIG. 9, referring to FIG. 10, the acquiring unit 11 may include a first acquiring subunit 111 and a first determining unit 112.

The first acquiring subunit 111 may be configured to acquire a hardware identification of the current playing device; the hardware identification may include a MAC address, an IMEI identification code, a CPU number or IP address; the hardware identification may also include two or more combinations of the MAC address, the IMEI identification code, the CPU number and the IP address.

The first determining unit 112 may be configured to determine the hardware identification as the identity information of the current playing device when the first acquiring subunit 111 acquires the hardware identification of the current playing device.

By the use of the device, because the MAC address, IMEI identification code, CPU number or IP address are unique identity information, the playing device and user information to which the playing device belongs may be acquired according to the MAC address, MME identification code, CPU number or IP address.

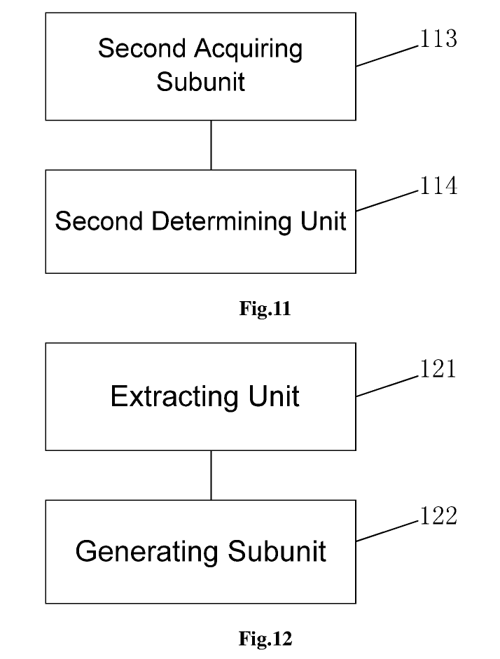

Additionally, based on FIG. 9, referring to FIG. 11, the acquiring unit 11 may also include a second acquiring subunit 113 and a second determining unit 114.

The second acquiring subunit 113 may be configured to acquire account information of the current playing device, wherein the account information is account information of a video player in the current playing device, or, account information of a program associated with the video player.

The second determining unit 114 may be configured to determine the account information as the identity information.

Using the device, because the account information is unique, in embodiments of the present disclosure, user information of the user corresponding to the account information may be prestored, thus, with the account information, information of the user using the video player or playing device may be determined.

Based on FIG. 9, referring to FIG. 12, the generating unit 12 of the device may include an extracting unit 121 and a generating subunit 122.

The extracting unit 121 may be configured to extract a character string of the identity information.

The generating subunit 122 may be configured to generate a character watermark comprising the character string, or generate a two-dimensional code watermark or a bar code watermark corresponding to the character string.

In embodiments of the present disclosure, the character watermark, the two-dimensional code watermark or the bar code watermark are all watermark information comprising a character string, thus, with the watermark information, the character string may be acquired; moreover, the character string may indicate a playing device for playing the video so that associated information of the playing device may be queried.

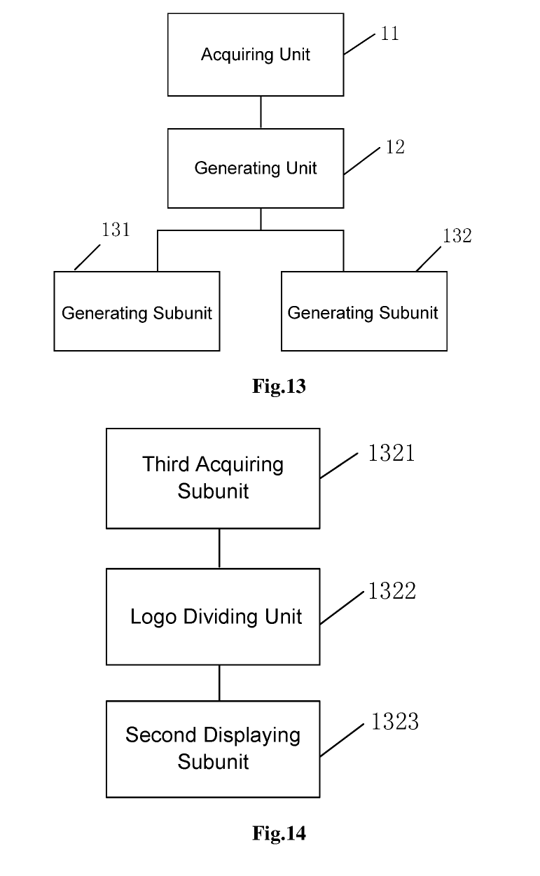

FIG. 13 is another structure diagram of a device for controlling video play according to embodiments of the present disclosure. Referring to FIG. 13, the device may include the acquiring unit 11, the generating unit 12 and a first displaying unit 131 or a second displaying unit 132.

The first displaying unit 131 may be configured to add the watermark logo into a video frame image of the video, and display the watermark logo.

The second displaying unit 132 may be configured to overlap and display the watermark logo on a playing image of the video in the playing interface.

In embodiments of the present disclosure, the watermark logo may be added into the video frame image of the video or the playing interface, wherein the video frame image and playing interface of the video are two separate displaying images, so as to display the watermark logo in different display ways.

Based on FIG. 13, referring to FIG. 14, the second displaying unit 132 may include a third acquiring subunit 1321, a logo dividing unit 1322 and a second displaying subunit 1323.

The third acquiring subunit 1321 may be configured to acquire a plurality of preset display positions in the playing interface of the video.

The logo dividing unit 1322 may be configured to divide the watermark logo into a plurality of sub logos, wherein the number of the sub logos is same to the number of the preset display positions.

The second displaying subunit 1323 may be configured to display one of the sub logos on a corresponding one of the plurality of preset display positions, respectively.

Using the device, by dividing the watermark logo into a plurality of sub logos and displaying the sub logos in different preset display positions, there may be a plurality of sub logos in the playing interface of the video, thereby increasing the difficulty of removing sub logos.

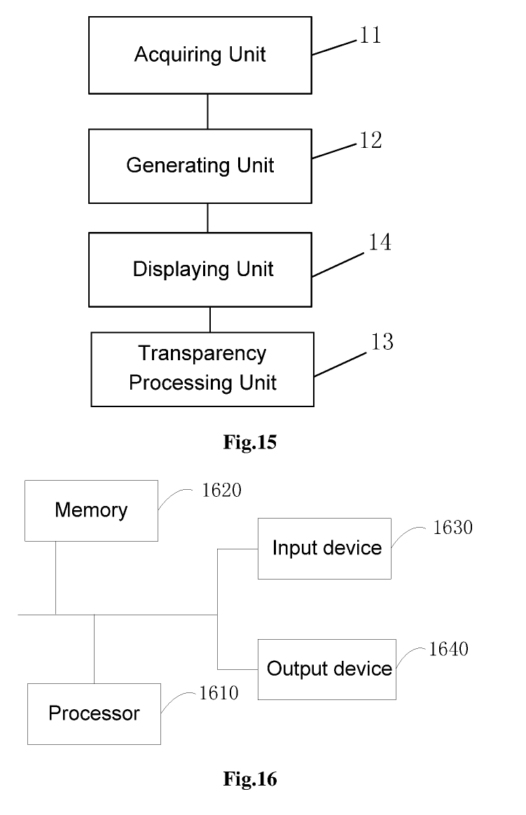

Based on FIG. 8, FIG. 15 is a structure diagram of a device for controlling video play. Referring to FIG. 15, the device may include the acquiring unit 11, the generating unit 12, a transparency processing unit 14 and the displaying unit 13.

The transparency processing unit 14 may be configured to process transparency of the watermark logo before displaying the watermark logo on the playing interface of the video so that the transparency level of the watermark is increased.

In embodiments of the present disclosure, the acquiring unit 11, the generating unit 12 and the displaying unit 13 may be referred to above embodiments as shown in FIG. 9; by processing the transparency of the watermark logo, the transparency level of the watermark logo may be increased, so that pirates cannot figure out whether the video has an anti-pirateship logo. Even though the video is pirated, identity information of the playing device may also be acquired by the watermark logo so as to acquire user information to which the playing device belongs, which improves video safety.

With respect to the device in above embodiments, the specific modes for performing operation of each module have been described in details in the embodiments relevant to the method, and detailed description is omitted here.

The embodiments of the present disclosure may further provide a non-volatile computer readable storage medium which is stored with computer executable instructions configured to perform the method for controlling video play according to any one of the above described method embodiments.

FIG. 16 is a hardware structure schematic illustrating an electronic device for controlling video play according to embodiments of the present disclosure. As shown in FIG. 16, the electronic device may comprise the following components.

One or more processor 1610 and a memory 1620 may be included. In FIG. 16, one processor 1610 may be taken as an example.

The input device 1630 and the output device 1640 may be further included.

The processor 1610, the memory 1620, the input device 1630 and the output device 1640 may be connected with each other through bus connection or other means. In FIG. 16, bus connection is taken as an example.

The memory 1620, as non-volatile computer readable storage medium, may be configured to be stored with non-volatile software program, non-volatile computer executable program and modules such as program instructions/modules according to the method for controlling video play of the embodiments of the present disclosure (for example, the acquiring unit 11, the generating unit 12 and the displaying unit 13 as illustrated in FIG. 9). The processor 1610 may perform various functional applications and data processing of the server by executing non-volatile software program stored in the memory 1620, to implement the method for controlling video play according to the embodiments of the present disclosure.

The memory 1620 may include a program storage area and a data storage area, wherein, the program storage area may be configured to be stored with an operating system and application for at least one function, and the data storage area may be stored with data created during the use of the device for controlling video play. Further, the memory 1620 may include a high-speed random access memory, and/or non-volatile memory, such as at least one magnetic disk storage device, flash memory device, or other non-volatile solid-state memory device. In some embodiments, the memory 1620 may include a memory remotely provided with respect to the processor 1610, which may be connected to the device for controlling video play through network connections, including but not limited to the internet, intranet, Local Area Network, mobile communication network and combinations thereof.

The input device 1630 may receive inputted information such as numbers or characters, and generate key signal input involving the user settings of the device for controlling video play and functional control. The output device 1640 may include a display device such as a display screen.

The one or more modules may be stored in the memory 1620, which, when executed by the at least one processor 1610, implements the method for controlling video play according to any one of the above method embodiments.

The above electronic device may perform the method provided by the embodiments of the present disclosure, have the corresponding functional modules and advantageous effects. The details which are not described in detail, may be referred to the method embodiments of the present disclosure.

The electronic device of the embodiments of the present disclosure may be in various forms, including but not limited to:

(1) mobile communication device: this type of device has mobile communication function, and is configured mainly for voice and data communication, including smart phone (iPhone), multi-media phone, functional phone and conventional phone.

(2) ultra-mobile personal computer device: a type of personal computer, having functions of calculation and processing, and mobile internet service, including, PDA, MID, and UMPC device, such as iPad.

(3) portable entertainment device: this type of device may display and play multi-media content, including an audio/video player (such as iPod), handheld game player, e-book, and smart toy and portable vehicle navigation device.

(4) server: a type of device providing computational service, including a processor, a hard disk, a memory, and a system bus, which has a similar frame as a general computer, and has a higher requirement in processability, stability, reliability, safety, extendability, and manageability.

(5) Other electronic devices having data interaction function.

The above-described device embodiments are only illustrative, wherein the components illustrated as separate may be or may be not physically separate, and the components displayed as units may be or may be not physical units, which may be located in one place or distributed over a plurality of network units. Some or all of the modules of the electronic device may be selected to be executed according to practical needs.

With the description of above method embodiments, one skilled in the art may clearly know that the present disclosure may be achieved by virtue of software plus necessary general hardware platforms, of course, it may also be achieved by hardware. Based on such an understanding, the technical solution of the present disclosure in essence or the part contributing to the related art may be presented in the form of a software product. The computer software product may be stored in a storage medium, containing some instructions to enable a computer device (such as a personal computer, a server, or network device and etc.) to perform some or all of steps of the method mentioned in each of the embodiments of the present disclosure. The aforementioned storage medium may comprise various media capable of storing program code, such as read-only memory (ROM), random access memory (RAM), magnetic disk and optical disk, etc.

Finally, the above embodiments are only intended for illustrating the present disclosure, rather than limiting it. Although the technical solutions of the present disclosure have been described in detail with reference to these embodiments, a person of ordinary skill in the art shall know that changes, substitutions variations or amendments may be made to these embodiments without departing from the scope and spirit of the present disclosure.

What is claimed is:

1. A method for controlling video play, comprising:
acquiring identity information of a current playing device when a video is played;
generating a watermark logo comprising the identity information; and
displaying the watermark logo on a playing interface of the video.

2. The method according to claim 1, wherein the acquiring identity information of a current playing device comprises:
acquiring a hardware identification of the current playing device, wherein the hardware identification comprises one or more combinations of a hardware physical address, an international mobile equipment identity, a central processing unit number and an internet protocol address; and
determining the hardware identification as the identity information.

3. The method according to claim 1, wherein the acquiring identity information of a current playing device comprises:
acquiring account information of the current playing device, wherein the account information is account information of a video player in the current playing device, or, account information of a program associated with the video player; and
determining the account information as the identity information.

4. The method according to claim 1, wherein the generating a watermark logo comprising the identity information comprises:
extracting a character string of the identity information; and
generating a character watermark comprising the character string, or generating a two-dimensional code watermark or a bar code watermark corresponding to the character string.

5. The method according to claim 1, wherein the displaying the watermark logo on a playing interface of the video comprises:
adding the watermark logo onto a video frame image of the video, and displaying the watermark logo;
or,
overlapping and displaying the watermark logo on a playing image of the video in the playing interface.

6. The method according to claim 5, wherein the overlapping and displaying the watermark logo on a playing image of the video in the playing interface comprises:
acquiring a plurality of preset display positions in the playing interface of the video;
dividing the watermark logo into a plurality of sub logos, wherein the number of the sub logos is same to the number of the preset display positions; and
displaying one of the sub logos on a corresponding one of the plurality of preset display positions, respectively.

7. A non-volatile computer readable storage medium which is stored with computer executable instructions configured to perform the following:
acquiring identity information of a current playing device when a video is played;
generating a watermark logo comprising the identity information; and
displaying the watermark logo on a playing interface of the video.

8. The non-volatile computer readable storage medium according to claim 7, wherein the acquiring identity information of a current playing device comprises:
acquiring a hardware identification of the current playing device, wherein the hardware identification comprises one or more combinations of a hardware physical address, an international mobile equipment identity, a central processing unit number and an internet protocol address; and
determining the hardware identification as the identity information.

9. The non-volatile computer readable storage medium according to claim 7, wherein the acquiring identity information of a current playing device comprises:
acquiring account information of the current playing device, wherein the account information is account information of a video player in the current playing device, or, account information of a program associated with the video player; and
determining the account information as the identity information.

10. The non-volatile computer readable storage medium according to claim 7, wherein the generating a watermark logo comprising the identity information comprises:
extracting a character string of the identity information; and
generating a character watermark comprising the character string, or generating a two-dimensional code watermark or a bar code watermark corresponding to the character string.

11. The non-volatile computer readable storage medium according to claim 7, wherein the displaying the watermark logo on a playing interface of the video comprises:
adding the watermark logo onto a video frame image of the video, and displaying the watermark logo;
or,
overlapping and displaying the watermark logo on a playing image of the video in the playing interface.

12. The non-volatile computer readable storage medium according to claim 11, wherein the overlapping and displaying the watermark logo on a playing image of the video in the playing interface comprises:
acquiring a plurality of preset display positions in the playing interface of the video;
dividing the watermark logo into a plurality of sub logos, wherein the number of the sub logos is same to the number of the preset display positions; and
displaying one of the sub logos on a corresponding one of the plurality of preset display positions, respectively.

13. An electronic device, comprising:
one or more processor; and
a memory;
wherein, the memory is stored with instructions which can be executed by the at least one processor, which, when executed by the at least one processor, enable the at least one processor to perform the following:
acquiring identity information of a current playing device when a video is played;
generating a watermark logo comprising the identity information; and
displaying the watermark logo on a playing interface of the video.

14. The electronic device according to claim 13, wherein the acquiring identity information of a current playing device comprises:
acquiring a hardware identification of the current playing device, wherein the hardware identification comprises one or more combinations of a hardware physical address, an international mobile equipment identity, a central processing unit number and an internet protocol address; and
determining the hardware identification as the identity information.

15. The electronic device according to claim 13, wherein the acquiring identity information of a current playing device comprises:
acquiring account information of the current playing device, wherein the account information is account information of a video player in the current playing device, or, account information of a program associated with the video player; and
determining the account information as the identity information.

16. The electronic device according to claim 13, wherein the generating a watermark logo comprising the identity information comprises:
extracting a character string of the identity information; and
generating a character watermark comprising the character string, or generating a two-dimensional code watermark or a bar code watermark corresponding to the character string.

17. The electronic device according to claim 13, wherein the displaying the watermark logo on a playing interface of the video comprises:
adding the watermark logo onto a video frame image of the video, and displaying the watermark logo;
or,
overlapping and displaying the watermark logo on a playing image of the video in the playing interface.

18. The electronic device according to claim 17, wherein the overlapping and displaying the watermark logo on a playing image of the video in the playing interface comprises:
acquiring a plurality of preset display positions in the playing interface of the video;
dividing the watermark logo into a plurality of sub logos, wherein the number of the sub logos is same to the number of the preset display positions; and
displaying one of the sub logos on a corresponding one of the plurality of preset display positions, respectively.
